(19) United States
(12) Patent Application Publication
(10) Pub. No.: US 2025/0307469 A1
(43) Pub. Date: Oct. 2, 2025

(54) APPLICATION PERMISSION MANAGEMENT

(71) Applicant: Beijing Zitiao Network Technology Co., Ltd., Beijing (CN)

(72) Inventor: Chao Han, Beijing (CN)

(21) Appl. No.: 18/768,407

(22) Filed: Jul. 10, 2024

(30) Foreign Application Priority Data
Mar. 29, 2024 (CN) 202410382470.2

(51) Int. Cl. G06F 21/62; G06F 21/60

(52) U.S. Cl. CPC G06F 21/629; G06F 21/604

(57) ABSTRACT

The embodiments of the present disclosure relate to method, apparatus, device and storage media for permission management. The method proposed here comprises: receiving a usage request for a target application in a platform, the usage request comprising token information; verifying the token information with token management data, the token management data being generated based on a token creation request of a target user associated with the target application, the token creation request at least indicating a specified permission of at least one workspace of the target user in the platform; in response to the token information being verified, determining whether a usage permission corresponding to the token information matches the usage request; and in response to the usage permission matching the usage request, responding to the usage request with the target application. In this way, the embodiments of the present disclosure may improve the flexibility of permission management.

### CROSS-REFERENCE TO RELATED APPLICATIONS

This application claims priority to Chinese Patent Application No. CN202410382470.2, filed on Mar. 29, 2024, and entitled “Method, Apparatus, Device and Storage Medium for Permission Management”, the entirety of which is incorporated herein by reference.

### FIELD

Example embodiments of the present disclosure relate generally to the field of computers, and in particular to application permission management.

### BACKGROUND

With the development of computer technology, the technical threshold for application development and deployment is rapidly declining. Ordinary users can also build corresponding applications by using low-code development platforms or other development platforms, for example. Some platforms allow users to open the interfaces of built applications to support more users or other applications to obtain services by invoking such interfaces.

### SUMMARY

In a first aspect of the present disclosure, a method of permission management is provided. The method comprises: receiving a usage request for a target application in a platform, the usage request comprising token information; verifying the token information with token management data, the token management data being generated based on a token creation request of a target user associated with the target application, the token creation request at least indicating a specified permission of at least one workspace of the target user in the platform; in response to the token information being verified, determining whether a usage permission corresponding to the token information matches the usage request; and in response to the usage permission matching the usage request, responding to the usage request with the target application.

In a second aspect of the present disclosure, an apparatus for permission management is provided. The apparatus comprises: a request receiving module, configured to receive a usage request for a target application in a platform, the usage request comprising token information; a first authentication module, configured to verify the token information with token management data, the token management data being generated based on a token creation request of a target user associated with the target application, the token creation request at least indicating a specified permission of at least one workspace of the target user in the platform; a second authentication module, configured to, in response to the token information being verified, determine whether a usage permission corresponding to the token information matches the usage request; and a request responding module, configured to, in response to the usage permission matching the usage request, respond to the usage request with the target application.

In a third aspect of the present disclosure, an electronic device is provided. The device comprises at least one processing unit; and at least one memory coupled to the at least one processing unit and storing instructions for execution by the at least one processing unit. The instructions, when executed by at least one processing unit, cause the device to perform the method of the first aspect.

In a fourth aspect of the present disclosure, a computer-readable storage medium is provided. A computer program is stored on the computer-readable storage medium, and the computer program may be executed by a processor to perform operations that implement the method of the first aspect.

It should be understood that content described in this content section is not intended to define key features or important features of the embodiments of the disclosure, nor is it intended to limit the scope of the disclosure. Other features of the disclosure will become apparent from the description below.

### BRIEF DESCRIPTION OF THE DRAWINGS

The above and other features, advantages and aspects of various embodiments of the present disclosure will become more apparent with reference to the following detailed description taken in conjunction with the accompanying drawings. In the drawings, the same or similar reference numbers represent the same or similar elements, where:

FIG. 1 shows a schematic diagram of an example environment.

FIG. 2 shows a schematic diagram of an example process of permission management of applications.

FIG. 3 illustrates example user interfaces.

FIG. 4 illustrates a flowchart of an example process for rights management.

FIG. 5 shows a schematic structural block diagram of an example apparatus for permission management.

FIG. 6 shows a block diagram of an example electronic device capable of implementing permissions management.

### DETAILED DESCRIPTION

Embodiments of the present disclosure will be described in more detail below with reference to the accompanying drawings. Although certain embodiments of the disclosure are shown in the drawings, it should be understood that the disclosure may be embodied in various forms and should not be construed as limited to the embodiments set forth herein, but rather, these embodiments are provided for greater clarity and a thorough and complete understanding of this disclosure. It should be understood that the drawings and embodiments of the present disclosure are for illustrative purposes only and are not intended to limit the scope of the present disclosure.

It is important to note that any section/subsection headings provided in this article are not limiting. Various embodiments are described throughout this article, and any type of embodiments can be included under any section/subsection. Furthermore, the embodiments described in any section/subsection may be combined in any way with any other embodiments described in the same section/subsection and/or in a different section/subsection.

In the description of embodiments of the present disclosure, the term “including” and similar expressions shall be understood as an open-ended inclusion, that is, “including but not limited to.” The term “based on” should be understood to mean “based at least in part on.” The term “an embodiment” or “the embodiment” shall be understood to mean “at least one embodiment”. The term “some embodiments” should be understood as “at least some embodiments”. Other explicit and implicit definitions may be included below. The terms “first”, “second”, etc. may refer to different or the same object. Other explicit and implicit definitions may be included below.

Embodiments of the present disclosure may relate to data of users, data acquisition and/or use of data, etc. All of these aspects follow respective legal regulations and related regulations. In embodiments of the present disclosure, all data collection, acquisition, processing, manufacturing, forwarding, using, and the like, are made with user acknowledgement and confirmation. Accordingly, when implementing the embodiments of the present disclosure, the user should be informed of a type, a usage range, a usage scenario, and the like of the data or information involved in an appropriate manner according to relevant legal regulations, and the authorization of the user is obtained. The specific informing and/or authorization manner may vary according to actual situations and application scenarios, and the scope of the present disclosure is not limited in this aspect.

In the solution of the present description and the embodiments, the personal information processing is performed on the basis of legitimacy (for example, the consent of the personal information body is obtained, or necessary for fulfillment of a contract, etc.), and the personal information processing is performed only within a predetermined range or a regulated range. The user's rejection of processing the personal information other than the necessary information required for processing the basic function will not affect the use of the basic function by the user.

As mentioned above, some platforms support users to open the interfaces of built applications to support more users or other applications to obtain services by invoking such interfaces. Therefore, how to effectively manage the permissions of interface invoking has become a focus of attention.

The embodiments of this disclosure propose a permission management solution. According to this solution, the solution comprises: receiving a usage request for a target application in a platform, the usage request comprising token information; verifying the token information with token management data, the token management data being generated based on a token creation request of a target user associated with the target application, the token creation request at least indicating a specified permission of at least one workspace of the target user in the platform; in response to the token information being verified, determining whether a usage permission corresponding to the token information matches the usage request; and in response to the usage permission matching the usage request, responding to the usage request with the target application.

In this way, the embodiments of the present disclosure are able to invoke the interface by creating a token and including the token in the request, and may improve the reliability of the authentication through secondary authentication, thereby improving the efficiency of application permission management.

Various example implementations of this solution are further described in detail below with reference to the accompanying drawings.

### Example Environment

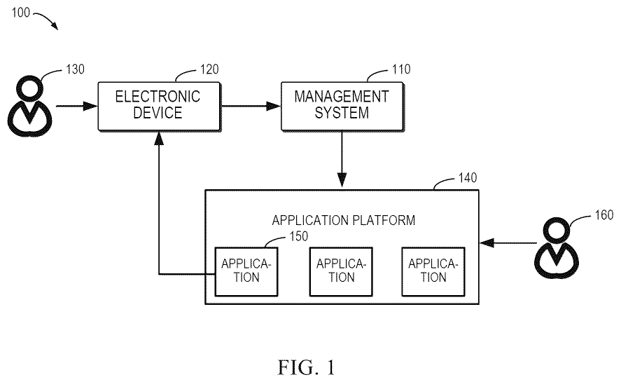

FIG. 1 shows a schematic diagram of an example environment 100 in which embodiments of the present disclosure can be implemented. As shown in FIG. 1, environment 100 may comprise management system 110.

As shown in FIG. 1, such a management system 110 may be associated with an application platform 140. In some embodiments, the application platform 140 may support a developer 160 to create and publish a corresponding application 150.

As an example, the application platform 140 may support users to create and manage different workspaces for developing or managing corresponding applications. In some examples, the application 150 may comprise, for example, a bot based on a machine learning model.

In some embodiments, the developer 160 may, for example, open the application programming interface (API) of the application 150 through the application platform 140 to support other users or applications to invoke the application 150 to perform corresponding tasks by invoking the interface.

As shown in FIG. 1, the user 130 may, for example, invoke the API of the application 150 through the electronic device 120 or an application installed in the electronic device 120 to perform the corresponding task.

As will be described in detail below, for the efficiency and the reliability of API invoking management, a request to invoke the API of the application 150 may be sent to the management system 110, so that the management system 110 determines whether the request is allowed based on the token information in the request.

In response to the request is allowed, for example, the request may be forwarded to application 150, to respond to the request with the application 150. The authentication process based on token information will be introduced in detail below and will not be detailed here.

It should be understood that the structure and function of various elements in environment 100 are described for illustrative purposes only and do not imply any limitation on the scope of the present disclosure.

Some example embodiments of the present disclosure will continue to be described below with reference to the accompanying drawings.

### Example Permission Management

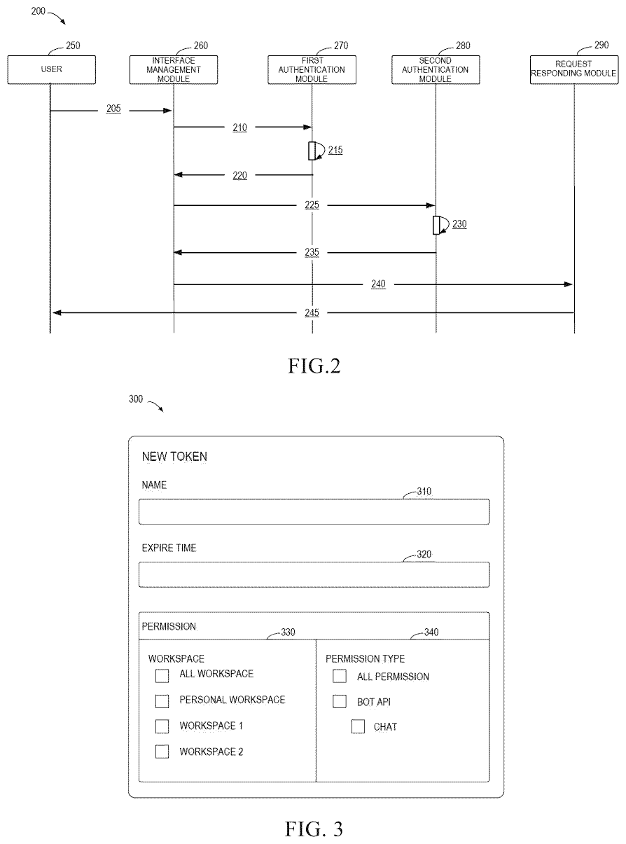

FIG. 2 shows a schematic diagram of an example process 200 for permission management in accordance with some embodiments of the present disclosure.

As shown in FIG. 2, at 205, the user 250 (for example, the user 130 shown in FIG. 1) may send a usage request for the target application (for example, the application 150 shown in FIG. 1) to the interface management module 260 with the electronic device 120 shown in FIG. 1.

In some embodiments, the usage request may be an invoking request corresponding to an application programming interface developed by the application 150. Additionally, the electronic device 120 may also add token information in the header of the invoking request.

In some embodiments, the token information may be generated based on a token creation request of a target user associated with the application 150 (e.g., developer 160 or administrative user). In some embodiments, such a token creation request may indicate a specified permission of at least one workspace of the target user in the platform.

FIG. 3 illustrates an example token creation interface 300 according to some embodiments of the present disclosure. As shown in FIG. 3, the interface 300 may comprise a control 330 for selecting a workspace and a control 340 for selecting a permission type.

As an example, the control 330 may list all workspaces of the target user in the platform, and may accept the user's selection of a workspace. In some embodiments, a single workspace may correspond to a single application (e.g., a bot), or may correspond to multiple applications.

For example, in response to the target user selecting “all workspaces” via the control 330, the token created may indicate specified permissions of applications under all workspaces.

Additionally, the control 340 may list the permission type that supports access to the application through the API invoking. For example, the permission types may include information about which types of APIs are allowed to be used, for example, chat APIs, or query APIs, etc.

In some embodiments, the permission types may also include, for example, permissions related to the application's knowledge base, such as permissions to create knowledge, permissions to delete knowledge, etc. Alternatively or additionally, the permission types may also include management permissions for the workspace, for example, permissions to obtain all applications under the workspace, permissions to create workspaces, permissions to delete workspaces, and so on.

Additionally or alternatively, the interface 300 may also include a control 310 for inputting an identification of the token and a control 320 for inputting a validity time of the token.

Further, after receiving input information of the target user in the interface 300, the management system 110 may create a corresponding token based on the input information. In some embodies, the plaintext information of the token may only be provided to the target user upon generation.

Additionally, a ciphertext version (e.g., hash value after hash operation) corresponding to the token may be stored as token information for being added to the usage request by the electronic device 120.

In some embodiments, the management system 110 may also perform encryption processing on the generated target token in response to receiving the token creation request, and store the encrypted data in the token management data for subsequent verification processes.

Specifically, as shown in FIG. 2, at 210, the interface management module 260 may send the token information included in the usage request to the first authentication module 270. At 215, the first authentication module 270 may verify the received token information with the token management data.

Specifically, the first authentication module 270 may, for example, perform corresponding encryption processing on the token information to determine whether the encrypted data matches the encrypted data in the token management data. If the two match, at 220, the first authentication module 270 may return the identity information corresponding to the token information to the interface management module 260. As an example, such identity information may include, for example, an identity ticket indicating the identity.

On the contrary, if the first authentication module 270 determines that the token information authentication fails, the first authentication module 270 may send a message regarding the authentication failure to the interface management module 260, and the interface management module 260 rejects the received usage request accordingly.

Further, the interface management module 260 may use the received identity information to determine whether the received usage request matches the corresponding usage permission. Specifically, as shown in FIG. 2, at 225, the interface management module 260 may send the identity information, the application identification of the target application, and the target action corresponding to the usage request to the second authentication module 280 (also called the permission management module).

As an example, the usage request may be an invocation of the chat API of the bot. Accordingly, the interface management module 260 may send the identity ticket received from the first authentication module 270, the identification of the bot, and the target action (i.e., chat) to the second authentication module 260.

At 230, the second authentication module 280 may determine the usage permission corresponding to the identity information and determine whether the usage permission matches the application representation and the target action. For example, in response to the created token indicating that the usage permission of the bot's chat API is present, the second authentication module 280 may determine that the usage permission corresponding to the identity information includes the usage permission of the bot's chat API, and may determine the usage permission matches the currently received usage request.

On the contrary, if the usage request is about an invocation of other types of APIs not included in the token, the second authentication module 280 may determine that its usage permission does not match the usage request.

As shown in FIG. 2, at 235, the second authentication module 280 may send the authentication information to the interface management module 260. The authentication information may, for example, indicate whether the usage permission determined based on the identity information matches the application identification and target action.

In some embodiments, if the authentication information indicates that the two match, the interface management module 260 may respond to the usage request with the target application. Specifically, as shown in FIG. 2, at step 240, the interface management module 260 may send the forward usage request or part of the usage request information to the request responding module 290. Further, at 245, the request responding module 290 may respond to the usage request with the target application, for example, sending a corresponding response message to the user 250.

Taking the chat scenario as an example, the application may, for example, generate a corresponding reply message based on the input message indicated in the usage request, and send the reply message to the user 250 as a response.

On the contrary, if the authentication information received from the second authentication module 280 indicates that the two do not match, the interface management module 260 may reject the usage request accordingly.

Based on the process described above, the embodiments of the present disclosure are able to invoke the interface by creating a token and including the token in the request, and may improve the reliability of the authentication through a secondary authentication, thereby improving the efficiency of permission management of the application.

### Example Process

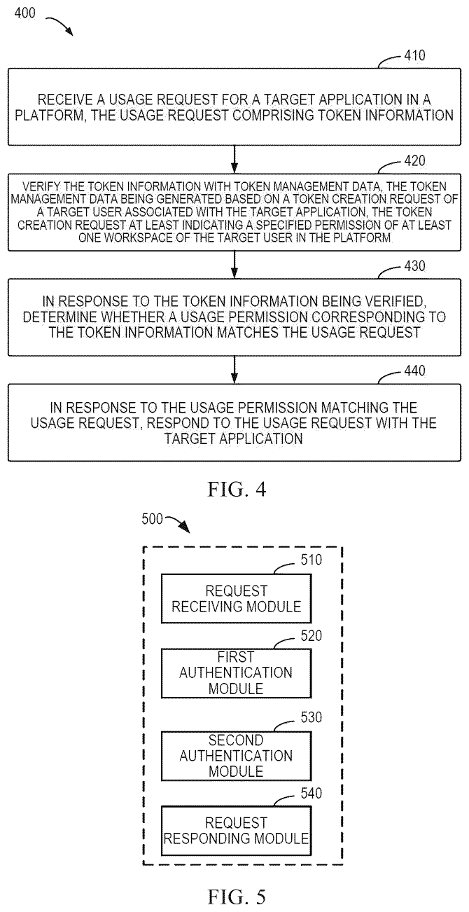

FIG. 4 illustrates a flow diagram of an example process 400 for permission management of some embodiments in accordance with the present disclosure. The process 400 may be implemented at management system 110. The process 400 is described below with reference to FIG. 1.

As shown in FIG. 4, at block 410, the management system 110 receives a usage request for a target application in a platform, the usage request comprising token information.

At block 420, the management system 110 verifies the token information with token management data, the token management data being generated based on a token creation request of a target user associated with the target application, the token creation request at least indicating a specified permission of at least one workspace of the target user in the platform.

At block 430, the management system 110 in response to the token information being verified, determines whether a usage permission corresponding to the token information matches the usage request.

At block 440, the management system 110, in response to the usage permission matching the usage request, responds to the usage request with the target application.

In some embodiments, the process 400 further comprises: providing a token creation interface to the target user, the token creation interface comprising a first control for selecting the workspace and a second control for selecting a permission type; and obtaining the token creation request based on input information received in the token creation interface.

In some embodiments, the token creation interface further comprises: a third control for inputting a token identification; and/or a fourth control for specifying valid time of a token.

In some embodiments, the process 400 further comprises: in response to receiving the token creation request, the management system performs an encryption processing on the target token generated based on the token creation request to update the token management data.

In some embodiments, the process 400 further comprises: providing target token information corresponding to the target token to the target user.

In some embodiments, in response to the token information being verified, the management system determines whether a usage permission corresponding to the token information matches the usage request. The determining comprises: in response to the token information being verified, obtaining identity information corresponding to the token information; and determining whether the usage permission corresponding to the identity information matches the usage request.

In some embodiments, the management system determines whether the usage permission corresponding to the identity information matches the usage request. The determining comprises: providing the identity information, an application identification of the target application and a target action corresponding to the usage request to a permission management module; and obtaining authentication information from the permission management module, the authentication information indicating whether the usage permission determined based on the identity information matches the application identification and the target action.

In some embodiments, the process 400 further comprises: in response to the token information failing to be verified, denying the usage request; or in response to the usage permission failing to match the usage request, denying the usage request.

In some embodiments, the target application is created by the target user with the target platform, and the usage request is an invoking to a target interface for the target application, the target interface being provided based on a configuration operation of the target user in the target platform.

In some embodies, the token information is included in a header of the usage request.

### Example Apparatus and Equipment

Embodiments of the present disclosure also provide a corresponding apparatus for implementing the above methods or processes. FIG. 5 shows a schematic structural block diagram of an example apparatus 500 for permission management according to certain embodiments of the present disclosure. The apparatus 500 may be implemented as or included in management system 110. Each module/component in the apparatus 500 may be implemented by hardware, software, firmware, or any combination thereof.

As shown in FIG. 5, the apparatus 500 includes a request receiving module 510, configured to receive a usage request for a target application in a platform, the usage request comprising token information; a first authentication module 520, configured to verify the token information with token management data, the token management data being generated based on a token creation request of a target user associated with the target application, the token creation request at least indicating a specified permission of at least one workspace of the target user in the platform; a second authentication module 530, configured to, in response to the token information being verified, determine whether a usage permission corresponding to the token information matches the usage request; and a request responding module 540, configured to, in response to the usage permission matching the usage request, respond to the usage request with the target application.

In some embodiments, the apparatus 500 further comprises a token creation module, configured to: provide a token creation interface to the target user, the token creation interface comprising a first control for selecting the workspace and a second control for selecting a permission type; and obtain the token creation request based on input information received in the token creation interface.

In some embodiments, the token creation interface further comprises: a third control for inputting a token identification; and/or a fourth control for specifying valid time of a token.

In some embodiments, the apparatus 500 further comprises a data management module configured to: in response to receiving the token creation request, perform an encryption processing on the target token generated based on the token creation request to update the token management data.

In some embodiments, the data management module is further configured to: provide target token information corresponding to the target token to the target user.

In some embodiments, the second authentication module 530 is further configured to: in response to the token information being verified, obtain identity information corresponding to the token information; and determine whether the usage permission corresponding to the identity information matches the usage request.

In some embodiments, the second authentication module 530 is further configured to: provide the identity information, an application identification of the target application and a target action corresponding to the usage request to a permission management module; and obtain authentication information from the permission management module, the authentication information indicating whether the usage permission determined based on the identity information matches the application identification and the target action.

In some embodiments, the apparatus 500 further comprises a request rejection module configured to: in response to the token information failing to be verified, deny the usage request; or in response to the usage permission failing to match the usage request, deny the usage request.

In some embodiments, the target application is created by the target user with the target platform, and the usage request is an invoking to a target interface for the target application, the target interface being provided based on a configuration operation of the target user in the target platform.

In some embodies, the token information is included in the header of the usage request.

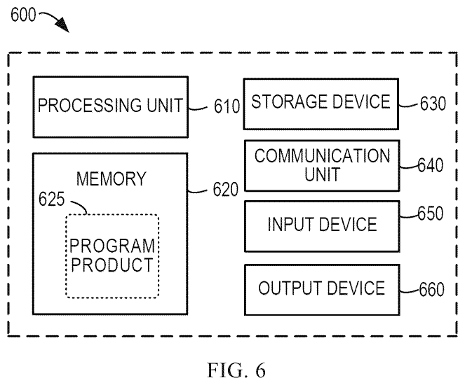

FIG. 6 shows a block diagram of an example electronic device 600 in which one or more embodiments of the present disclosure may be implemented. It should be understood that the electronic device 600 shown in FIG. 6 is merely exemplary and should not constitute any limitation on the functionality and scope of the embodiments described herein. The electronic device 600 shown in FIG. 6 may be used to implement the management system 110 of FIG. 1.

As shown in FIG. 6, the electronic device 600 is in the form of a general electronic device. Components of electronic device 600 may include, but are not limited to, one or more processors or processing units 610, memory 620, storage devices 630, one or more communication units 640, one or more input devices 650, and one or more output devices 660. The processing unit 610 may be a real or virtual processor and can perform various processes according to a program stored in the memory 620. In a multi-processor system, multiple processing units execute computer-executable instructions in parallel to improve the parallel processing capability of the electronic device 600.

The electronic device 600 typically includes a plurality of computer storage media. Such media may be any obtainable media accessible to electronic device 600, including but not limited to volatile and nonvolatile media, removable and non-removable media. The memory 620 may be volatile memory (e.g., registers, cache, random access memory (RAM)), nonvolatile memory (e.g., read only memory (ROM), electrically erasable programmable read only memory (EEPROM)), flash memory) or some combination thereof. Storage device 630 may be a removable or non-removable medium and may include machine-readable media such as a flash drive, a magnetic disk, or any other medium that may be capable of storing information and/or data and may be accessed within electronic device 600.

The electronic device 600 may further comprise additional removable/non-removable, volatile/nonvolatile storage media. Although not shown in FIG. 6, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. In addition, functions of components of the electronic device 600 may be implemented by a single computing cluster or a plurality of computing machines, and these computing machines can communicate through a communication connection. Accordingly, the electronic device 600 may operate in a networked environment using logical connections to one or more other servers, network personal computers (PCs), or another network node.

The input device 650 may be one or more input devices such as a mouse, keyboard, trackball, etc. The output device 660 may be one or more output devices such as a display, speakers, printer, etc. The electronic device 600 may also communicate with one or more external devices (not shown), such as storage devices, display devices, etc., as needed through the communication unit 640, with one or more devices that enable a user to interact with the electronic device 600, or with any device (e.g., network card, modem, etc.) that enables the electronic device 600 to communicate with one or more other electronic devices. Such communication may be performed via an input/output (I/O) interface (not shown).

According to an example implementation of the present disclosure, a computer-readable storage medium is provided, on which a computer-executable instruction is stored, wherein the computer-executable instruction is executed by a processor to perform operation that implement the above-described method. According to an exemplary implementation of the present disclosure, there is also provided a computer program product, which is tangibly stored on a non-transitory computer-readable medium and includes computer-executable instructions that are executed by a processor to perform operations that implement the method described above.

Aspects of the present disclosure are described herein with reference to flowchart illustrations and/or block diagrams of methods, apparatus, devices and computer program products implemented in accordance with the present disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processing unit of a general purpose computer, special purpose computer, or other programmable data processing apparatus to produce a machine, such that the instructions, which execute via the processing unit of the computer or other programmable data processing apparatus, create means for implementing the functions/acts specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions includes an article of manufacture including instructions which implement various aspects of the functions/acts specified in the flowchart and/or block diagram block or blocks.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions which execute on the computer, other programmable data processing apparatus, or other devices implement the functions/acts specified in the flowchart and/or block diagram block or blocks.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, segment, or portion of an instruction which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described implementations of the disclosure above, the foregoing description is exemplary, not exhaustive, and is not limited to the implementations disclosed. Many modifications and variations will be apparent to those of ordinary skill in the art without departing from the scope and spirit of the implementations described. The choice of terms used herein is intended to best explain the principles of the implementations, the practical application, or improvements to technologies in the marketplace, or to enable others of ordinary skill in the art to understand the implementations disclosed herein.

1. A method of permission management, comprising:
receiving a usage request for a target application of a platform, the usage request comprising token information;
verifying the token information with token management data, the token management data being generated based on a token creation request of a target user associated with the target application, the token creation request indicating at least a specified permission of at least one workspace of the target user in the platform;
in response to the token information being verified, determining whether a usage permission corresponding to the token information matches the usage request; and
in response to the usage permission matching the usage request, responding to the usage request with the target application.

2. The method of claim 1, further comprising:
providing a token creation interface to the target user, the token creation interface comprising a first control for selecting the workspace and a second control for selecting a permission type; and
obtaining the token creation request based on input information received in the token creation interface.

3. The method of claim 2, wherein the token creation interface further comprises one or more of:
a third control for inputting a token identification; or
a fourth control for specifying valid time of a token.

4. The method of claim 1, further comprising:
in response to receiving the token creation request, performing an encryption processing on the target token generated based on the token creation request to update the token management data.

5. The method of claim 4, further comprising:
providing target token information corresponding to the target token to the target user.

6. The method of claim 1, wherein in response to the token information being verified, determining whether a usage permission corresponding to the token information matches the usage request, the determining comprising:
in response to the token information being verified, obtaining identity information corresponding to the token information; and
determining whether the usage permission corresponding to the identity information matches the usage request.

7. The method of claim 6, wherein determining whether the usage permission corresponding to the identity information matches the usage request comprises:
providing the identity information, an application identification of the target application and a target action corresponding to the usage request to a permission management module; and
obtaining authentication information from the permission management module, the authentication information indicating whether the usage permission determined based on the identity information matches the application identification and the target action.

8. The method of claim 1, further comprising:
in response to the token information failing to be verified, denying the usage request; or
in response to the usage permission failing to match the usage request, denying the usage request.

9. The method of claim 1, wherein the target application is created by the target user with the target platform, and the usage request is an invocation of a target interface for the target application, the target interface being provided based on a configuration operation of the target user in the target platform.

10. The method of claim 1, wherein the token information is included in a header of the usage request.

11. An electronic device, comprising:
at least one processing unit; and
at least one memory coupled to the at least one processing unit and storing instructions for execution by the at least one processing unit, in response to the instructions being executed by the at least one processing unit causing the electronic device to perform a method of permission management comprising:
receiving a usage request for a target application of a platform, the usage request comprising token information;
verifying the token information with token management data, the token management data being generated based on a token creation request of a target user associated with the target application, the token creation request at least indicating at least a specified permission of at least one workspace of the target user in the platform;
in response to the token information being verified, determining whether a usage permission corresponding to the token information matches the usage request; and
in response to the usage permission matching the usage request, responding to the usage request with the target application.

12. The electronic device of claim 11, the method further comprising:
providing a token creation interface to the target user, the token creation interface comprising a first control for selecting the workspace and a second control for selecting a permission type; and
obtaining the token creation request based on input information received in the token creation interface.

13. The electronic device of claim 12, wherein the token creation interface further comprises one or more of:
a third control for inputting a token identification; or
a fourth control for specifying valid time of a token.

14. The electronic device of claim 11, the method further comprising:
in response to receiving the token creation request, performing an encryption processing on the target token generated based on the token creation request to update the token management data.

15. The electronic device of claim 14, the method further comprising:
providing target token information corresponding to the target token to the target user.

16. The electronic device of claim 11, wherein in response to the token information being verified, determining whether a usage permission corresponding to the token information matches the usage request, the determining comprising:
in response to the token information being verified, obtaining identity information corresponding to the token information; and
determining whether the usage permission corresponding to the identity information matches the usage request.

17. The electronic device of claim 15, wherein determining whether the usage permission corresponding to the identity information matches the usage request comprises:
providing the identity information, an application identification of the target application and a target action corresponding to the usage request to a permission management module; and
obtaining authentication information from the permission management module, the authentication information indicating whether the usage permission determined based on the identity information matches the application identification and the target action.

18. The electronic device of claim 11, the method further comprising:
in response to the token information failing to be verified, denying the usage request; or
in response to the usage permission failing to match the usage request, denying the usage request.

19. The electronic device of claim 11, wherein the target application is created by the target user with the target platform, and the usage request is an invocation of a target interface for the target application, the target interface being provided based on a configuration operation of the target user in the target platform.

20. A non-transitory computer-readable storage medium having a computer program stored thereon, the computer program being executable by a processor to implement the method of permission management comprising:
receiving a usage request for a target application of a platform, the usage request comprising token information;
verifying the token information with token management data, the token management data being generated based on a token creation request of a target user associated with the target application, the token creation request indicating at least a specified permission of at least one workspace of the target user in the platform;
in response to the token information being verified, determining whether a usage permission corresponding to the token information matches the usage request; and
in response to the usage permission matching the usage request, responding to the usage request with the target application.
